(19) United States
(12) Patent Application Publication
(10) Pub. No.: US 2011/0278353 A1
(43) Pub. Date: Nov. 17, 2011

(54) Carton With Handle

(76) Inventor: Emili Requena, Igualada (ES)

(21) Appl. No.: 12/779,274

(22) Filed: May 13, 2010

(51) Int. Cl. B65D 5/46; B31B 3/00

(52) U.S. Cl. 229/117.12; 493/162

(57) ABSTRACT

A carton for holding a plurality of containers. The carton comprises a plurality of panels that extend at least partially around an interior of the carton with an at least partially open top. The panels comprise a bottom panel, a first side panel, and a second side panel. The carton includes at least one end flap at least partially closing a first end of the carton, a handle panel foldably connected to at least one of the first side panel and the second side panel, and a reinforcement panel foldably connected to the handle panel.

### BACKGROUND OF THE DISCLOSURE

The present disclosure generally relates to carriers or cartons for holding and displaying containers. More specifically, the present disclosure relates to cartons with a handle extending across an at least partially open top.

### SUMMARY OF THE DISCLOSURE

In general, one aspect of the disclosure is directed to a carton for holding a plurality of containers. The carton comprises panels that extend at least partially around an interior of the carton with an at least partially open top. The panels comprise a bottom panel, a first side panel, and a second side panel. The carton also comprises at least one end flap at least partially closing a first end of the carton, a handle panel foldably connected to at least one of the first side panel and the second side panel, and a reinforcement panel foldably connected to the handle panel.

In another aspect, the disclosure is generally directed to a blank for forming a carton with an at least partially open top. The blank comprises a plurality of panels comprising a bottom panel, a first side panel foldably connected to the bottom panel, and a second side panel foldably connected to the bottom panel. The blank also comprises a plurality of end flaps extending along a marginal area of the blank, a handle panel foldably connected to at least one of the first side panel and the second side panel, and a reinforcement panel foldably connected to the handle panel.

In another aspect, the disclosure is generally directed to a method of forming a blank into a carton for containing a plurality of containers. The method comprises obtaining a blank comprising a plurality of panels comprising a bottom panel, a first side panel connected to the bottom panel, a second side panel connected to the bottom panel, a plurality of end flaps extending along a marginal area of the blank, a handle panel foldably connected to at least one of the first side panel and the second side panel, and a reinforcement panel foldably connected to the handle panel. The method also comprises forming an interior of the carton with an at least partially open top by respectively folding the plurality of panels and the plurality of end flaps.

Those skilled in the art will appreciate the above stated advantages and other advantages and benefits of various additional embodiments reading the following detailed description of the embodiments with reference to the below-listed drawing figures.

According to common practice, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

FIG. 1 is a plan view of a carton blank used to form an exemplary carton according to one embodiment of the disclosure.

FIG. 2 is a perspective view of the interior of the blank of FIG. 1

FIG. 3 is a perspective view of the handle panel and reinforcement panel according to one embodiment of the disclosure.

FIGS. 4 and 5 are perspective views of the carton according to one embodiment of the disclosure.

FIG. 6 is a perspective view of a carton according to a second embodiment of the disclosure.

FIG. 7 is a plan view of a carton blank used to form an exemplary carton according to a third embodiment of the disclosure.

FIG. 8 is a perspective view of the carton formed from the blank of FIG. 7.

Corresponding parts are designated by corresponding reference numbers throughout the drawings.

### DETAILED DESCRIPTION OF THE EXEMPLARY EMBODIMENTS

The present disclosure generally relates to cartons that contain articles such as containers, bottles, cans, etc. The articles can be used for packaging food and beverage products, for example. The articles can be made from materials suitable in composition for packaging the particular food or beverage item, and the materials include, but are not limited to, glass; aluminum and/or other metals; plastics such as PET, LDPE, LLDPE, HDPE, PP, PS, PVC, EVOH, and Nylon; and the like, or any combination thereof.

Cartons according to the present disclosure can accommodate articles of any shape. For the purpose of illustration and not for the purpose of limiting the scope of the disclosure, the following detailed description describes beverage containers (e.g., aluminum beverage cans) as disposed within the carton embodiments. In this specification, the terms “lower,” “bottom,” “upper,” and “top” indicate orientations determined in relation to fully erected and upright cartons.

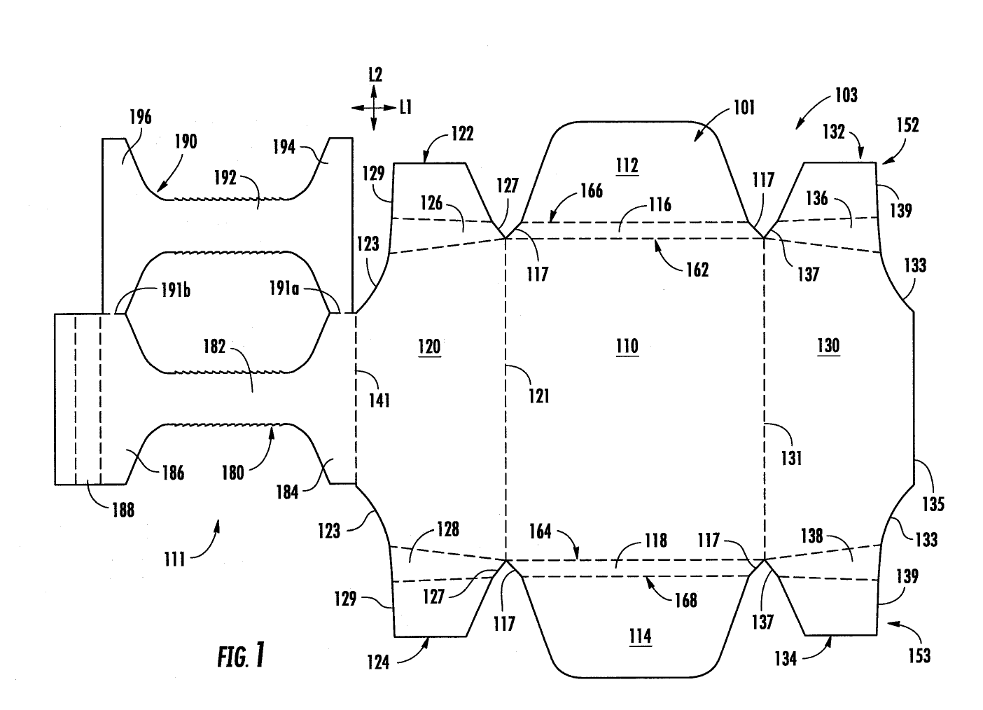

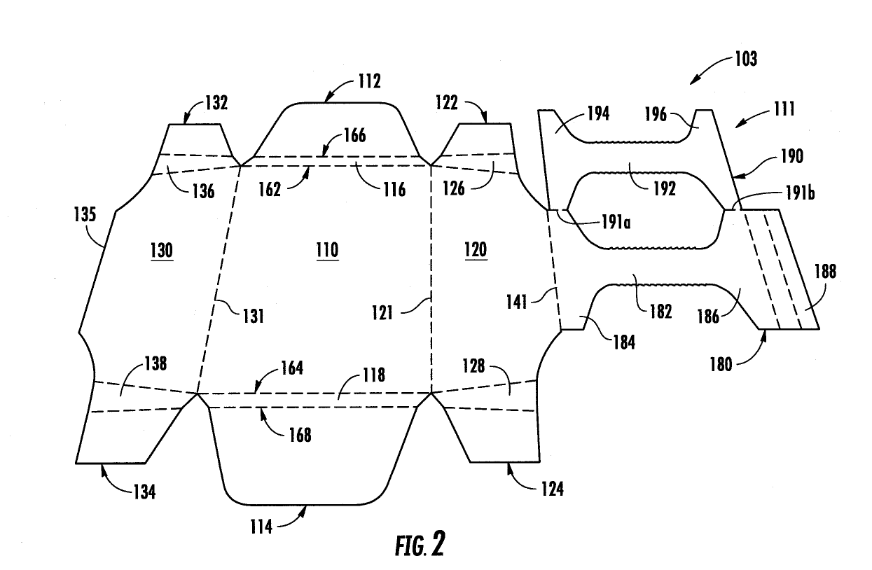

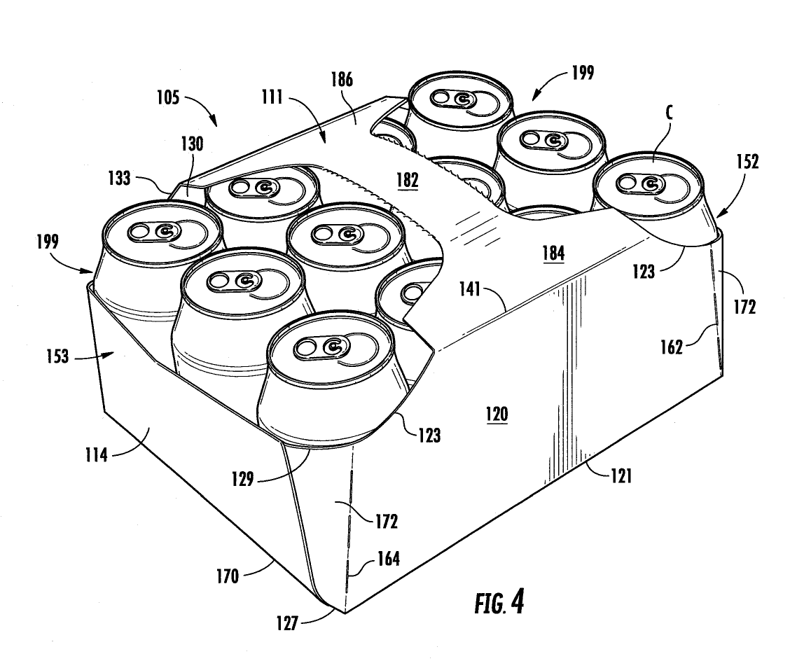

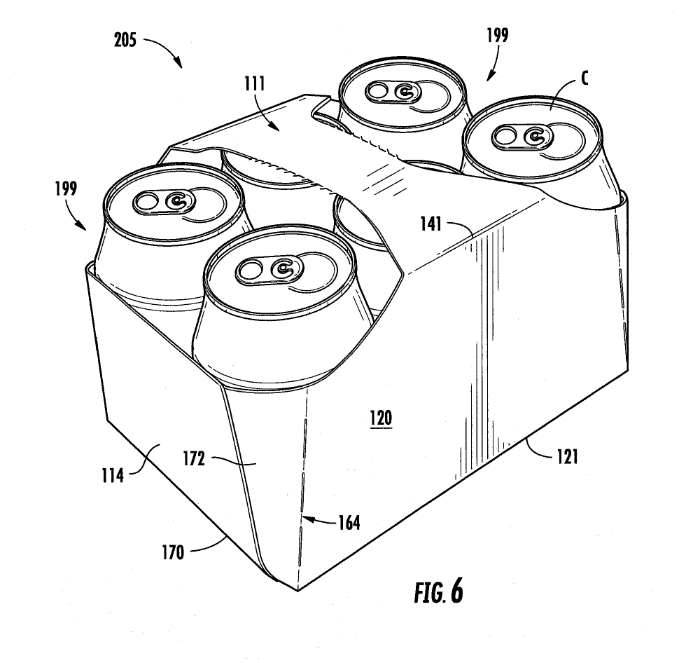

FIG. 1 is a plan view of the exterior side 101 of a blank, generally indicated at 103, used to form a carton 105 (FIG. 4) according to one exemplary embodiment of the disclosure. FIG. 2 is a view of the interior side of the blank 103. The carton 105 can be used to house a plurality of articles such as containers C. The carton 105 has an at least partially open top formed in the carton for allowing access to the containers and displaying the containers. In the illustrated embodiment, the carton 105 (FIG. 4) is sized to house twelve containers C in a single layer in a 3×4 arrangement, and, in an alternative embodiment, the carton 205 (FIG. 6) is sized to house six containers C in a 2×3 arrangement. However, the cartons 105, 205 may be sized and shaped to hold containers of a different or same quantity in more than one layer and/or in different row/column arrangements (e.g., 1×6, 3×5, 2×6×2, 3×4×2, 2×9, 2×6, 3×6, etc.). In the illustrated embodiment, the carton 105 includes a handle, generally indicated at 111 (FIG. 4), for grasping and carrying the carton. As will be discussed below in more detail, the handle 111 is formed from at least a handle panel and a reinforcement panel.

The blank 103 has a longitudinal axis L1 and a transverse or lateral axis L2. In the illustrated embodiment, the blank 103 comprises a bottom panel 110 foldably connected to a first side panel 120 at a first transverse fold line 121 and a second side panel 130 foldably connected to the bottom panel 110 at a second transverse fold line 131.

The bottom panel 110 is foldably connected to a first bottom end flap 112 and a second bottom end flap 114. The first side panel 120 is foldably connected to a first side end flap 122 and a second side end flap 124. The second side panel 130 is foldably connected to a first side end flap 132 and a second side end flap 134.

In the illustrated embodiment, the first bottom end flap 112 and first side end flaps 122, 132 extend along a first marginal area of the blank 103, and are foldably connected at a first corner fold line 162 that extends along the length of the blank. The second bottom end flap 114 and second side end flaps 124, 134 extend along a second marginal area of the blank 103, and are foldably connected at a second corner fold line 164 that also extends along the length of the blank. The corner fold lines 162, 164 may be, for example, substantially straight, or offset at one or more locations to account for blank thickness or for other factors. In the illustrated embodiment, the corner fold lines 162, 164 are generally longitudinal in the bottom panel 110 and oblique in the side panels 120, 130.

In the illustrated embodiment, a third corner fold line 166 extends across the first bottom end flap 112 and the first side end flaps 122, 132 to define a first bottom corner section 116 and first side corner sections 126, 136 between the first and third corner fold lines 162, 166. A fourth corner fold line 168 extends across the second bottom end flap 114 and the second side end flaps 124, 134 to define a second bottom corner section 118 and second side corner sections 128, 138. In one embodiment, the corner sections 126, 128 can have oblique edges 127 extending from respective ends of the first transverse fold line 121, and the corner sections 136, 138 have oblique edges 137 extending from respective ends of the second transverse fold line 131. Similarly, the bottom corner sections 116, 118 have oblique edges 117 extending from respective transverse fold lines 121, 131.

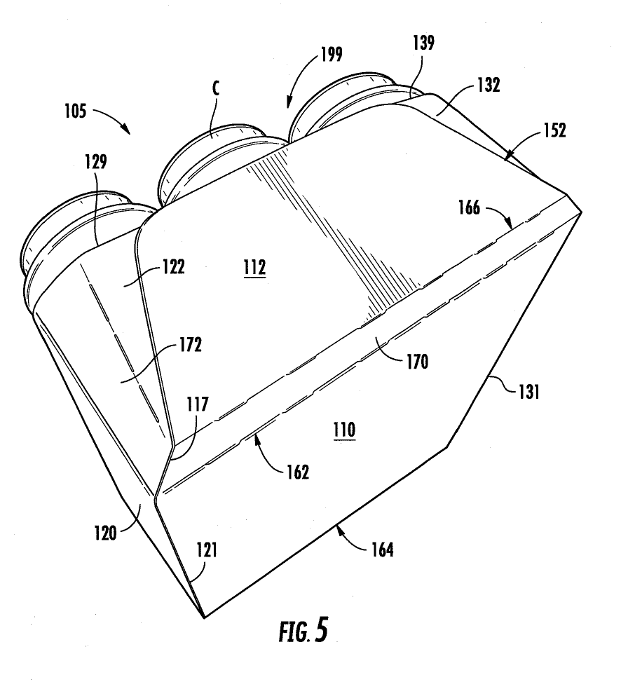

When the carton 105 is erected, the first bottom end flap 112 and first side end flaps 122, 132 at least partially close a first end 152 (FIG. 4) of the carton, and the second bottom end flap 114 and second side end flaps 124, 134 at least partially close a second end 153 of the carton. The bottom corner sections 116, 118 form bottom prism corners 170, and the side corner sections 126, 128, 136, 138 form side prism corners 172 (FIGS. 4 and 5). In accordance with an alternative embodiment of the present disclosure, different flap arrangements can be used for closing the ends 152, 153 of the carton 105.

As shown in FIG. 1, the features that form the handle 111 of the carton 105 can include an elongate handle panel 180 foldably connected to the first side panel 120 at a third transverse fold line 141 and a reinforcement flap 190 foldably connected to the handle panel 180. In the illustrated embodiment, the handle panel 180 includes a handle portion 182 and first and second flanges 184, 186, where the handle portion is narrow relative to the flanges. Glue flaps 188 are foldably connected to the second flange 186. The reinforcement panel 190 has a shape that generally corresponds to the shape of the handle panel 180 with a handle portion 192 and flanges 194, 196. The reinforcement panel 190 is connected to the handle panel 180 at handle fold lines 191a, 191b connecting the flanges 194, 196 to the respective flanges 184, 186.

In the illustrated embodiment, the first side panel 120 includes concave curved edges 123 extending from the third transverse fold line 141 to respective top edges 129 of the side end flaps 122, 124. Similarly, the second side panel 130 includes concave curved edges 133 extending from a transverse top edge 135 of the second side panel to respective top edges 139 of the side end flaps 132, 134. When the carton 105 is erected, the glue flaps 188 can be adhered to the second side panel 130 so that the second flange 186 generally lines up with the transverse edge 135 and the curved edges 123, 133 and the shape of the handle panel 180 form a partially open top with openings 199 (FIG. 4).

The handle 111 may be otherwise shaped and located in the carton 105 and may include other features not shown or described herein without departing from the scope of this disclosure.

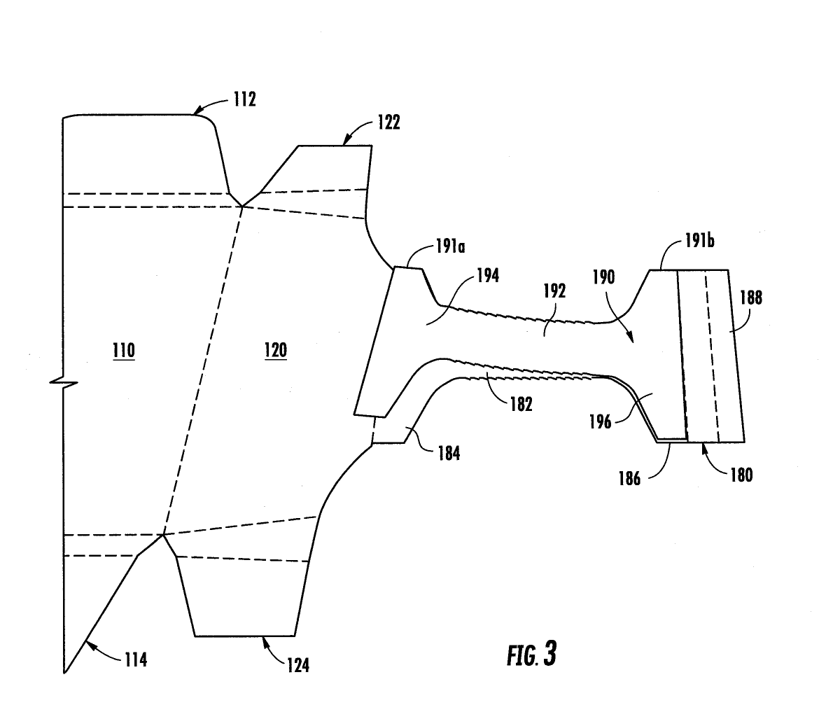

In accordance with one exemplary embodiment, the blank 103 can be erected into the carton 105 by folding the reinforcement panel 190 along the handle fold lines 191a, 191b so that the reinforcement panel is in face-to-face contact with the interior surface of the handle panel 180 (FIG. 3) to form the handle 111. The reinforcement panel 190 can be secured to the handle panel 180 with an adhesive, and the reinforcement panel and handle panel may have different degrees of overlap than shown in the figures without departing from the scope of the disclosure. Articles C can be loaded onto the bottom panel 110 before or after forming the handle 111. The articles may overlap the bottom corner sections 116, 118. The blank 103 is then folded along fold lines 121, 131 to position the first and second side panels 120, 130 to be generally perpendicular to the bottom panel 110.

The first side end flaps 122, 132 and the first bottom end flap 112 can be folded along the corner fold lines 162, 166 and adhered together to close the first end 152. In the illustrated embodiment shown in FIG. 4, the first end flaps 122, 132 are glued to the inner surface of the bottom end flap 112 with the oblique edges 127, 137 of the side corner sections 126, 136 generally overlapping the respective oblique edges 117 of the bottom corner section 116 and the top edges 129, 139 of the first end flaps generally aligning with the top edge of the bottom end flap 112. Similarly, the second side end flaps 124, 134 and the second bottom end flap 114 can be folded along the corner fold lines 164, 168 and adhered together to close the second end 153. In the illustrated embodiment, the second end flaps 124, 134 are glued to the inner surface of the bottom end flap 114 with the oblique edges 127, 137 of the side corner sections 128, 138 generally overlapping the respective oblique edges 117 of the bottom corner section 118 and the top edges 129, 139 of the second end flaps generally aligning with the top edge of the bottom end flap 114.

In the illustrated embodiment shown in FIGS. 4 and 5, the prism corners 170, formed from the bottom corner sections 116, 118, can extend obliquely with respect to the bottom panel 110 to generally follow the shape of the articles. For example, the articles may narrow towards their respective bottoms. The prism corners 172, formed from the side corner sections 126, 128, 136, 138, can be angled with respect to the side panels and bottom end panels and can be curved to follow the shape of the articles in the corners of the carton. The prism corners 170, 172 thus can provide a snug fit for the articles C and reduce wasted space in the carton 105.

The handle 111 can then be folded over the third transverse fold line 141 to extend across the partially open top of the carton. The glue flaps 188 are adhered to the second side panel 130 so that the flange 186 generally aligns with the transverse edge 135 of the second side panel 130. In the illustrated embodiment, the openings 199 can be formed on either side of the handle 111 to display and provide access to the articles C. In the illustrated embodiment, the transverse fold line 141 and transverse edge 135 can extend higher than the articles C to provide space below the handle 111 so that multiple fingers of a user can extend around the handle portions 182, 192 of the handle panel 180 and reinforcement panel 190. The curved edges 123, 133 of the side panels 120, 130, the top edges 129, 139 of the side end flaps, and the top edges of the bottom end flaps can extend below the tops of the articles to expose the upper portions of the articles for display and access to the articles.

Alternative folding and loading sequences to that described above may be used to erect carton 105, and the articles C can be loaded into the carton 105 at any time during or after erection of the carton without departing from the scope of the disclosure. Further, the blank 103 can be otherwise configured to have multiple bottom panels, multiple side panels, or both without departing from the scope of this disclosure. Even further, the carton 105 may be a wrap-around type carton, with the blank 103 including locking features that can include primary and secondary locking features as is known in the art.

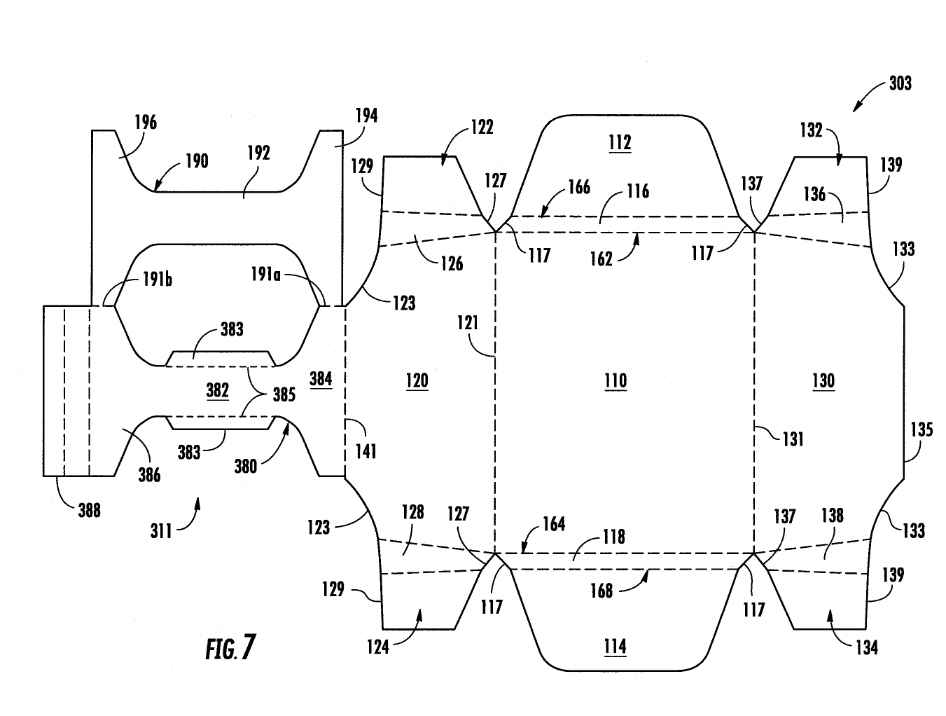

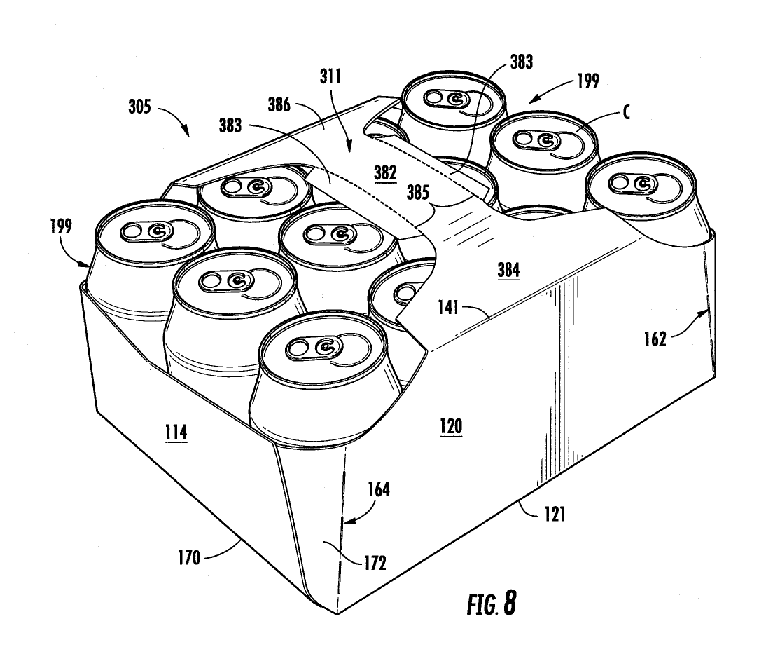

In an alternative embodiment shown in FIGS. 7 and 8, the blank 303 can include a handle 311 with a handle panel 380 and reinforcement panel 190. Features of the blank 303 and carton 305 that are similar or identical to the features of the blank 103 and carton 105 have the same reference numbers. In the embodiment illustrated in FIG. 7, the handle panel 380 can have a handle portion 382, flanges 384, 386, and guard flaps 383. The guard flaps 383 are foldably connected to the handle portion 382 along fold lines 385. When the handle 311 of the erected carton 305 (FIG. 8) is grasped by the user, the guard flaps 383 are folded along the fold lines 385 and the flaps cover the respective edges of the handle portion 192 of the reinforcement panel 190 to protect the user's hands. In addition, or in the alternative, guard flaps can be included on the handle portion of the reinforcement panel 190 (not shown).

The carton 305 can be erected from a blank in the manner described above with respect to the carton 105, or in an alternative manner.

The blank according to the present disclosure can be, for example, formed from coated paperboard and similar materials. For example, the interior and/or exterior sides of the blank can be coated with a clay coating. The clay coating may then be printed over with product, advertising, price coding, and other information or images. The blank may then be coated with a varnish to protect any information printed on the blank. The blank may also be coated with, for example, a moisture barrier layer, on either or both sides of the blank. In accordance with the above-described embodiments, the blank may be constructed of paperboard of a caliper such that it is heavier and more rigid than ordinary paper. The blank can also be constructed of other materials, such as cardboard, hard paper, or any other material having properties suitable for enabling the carton to function at least generally as described herein. The blank can also be laminated or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines may include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carton for holding a plurality of containers, the carton comprising:
a plurality of panels that extend at least partially around an interior of the carton with an at least partially open top, the panels comprising a bottom panel, a first side panel, and a second side panel;
at least one end flap at least partially closing a first end of the carton;
a handle panel foldably connected to at least one of the first side panel and the second side panel; and
a reinforcement panel foldably connected to the handle panel.

2. The carton of claim 1, wherein the handle panel is adhered to at least the second side panel, and the reinforcement panel is at least partially in face-to-face contact with the handle panel.

3. The carton of claim 1, wherein the handle panel is foldably connected at the top of the at least one of the first side panel and the second side panel and extends across the at least partially open top.

4. The carton of claim 1, wherein the handle panel comprises a handle portion and at least one handle flange, wherein the reinforcement panel is foldably connected to the at least one handle flange.

5. The carton of claim 4, wherein the handle portion is narrower than the at least one handle flange.

6. The carton of claim 5, wherein the reinforcement panel comprises a reinforcement handle portion and at least one reinforcement flange, wherein the reinforcement handle portion and the at least one reinforcement flange are correspondingly shaped to the handle portion and the at least one handle flange of the handle panel.

7. The carton of claim 6, wherein the reinforcement panel is at least partially in face-to-face contact with the handle panel.

8. The carton of claim 5, wherein the handle panel further comprises at least two handle flaps, each handle flap being foldably connected to the handle portion of the handle panel.

9. The carton of claim 4, wherein the handle portion comprises at least one jagged edge.

10. The carton of claim 4, wherein the at least one handle flange comprises a first handle flange foldably connected to the at least one of the first and second side panels and a second handle flange foldably connected to an adhesive flap.

11. The carton of claim 4, wherein the at least one handle flange is foldably connected to an adhesive flap, the adhesive flap comprising a transverse intermediate fold line.

12. The carton of claim 4, wherein the at least one handle flange is connected to the first side panel at a transverse fold line and the first side panel comprises at least one first curved edge extending from the transverse fold line, wherein the at least one first curved edge is concave.

13. The carton of claim 12, wherein the second side panel comprises a transverse edge and at least one second curved edge extending from the transverse edge, wherein the at least one second curved edge is concave, and the transverse edge overlaps a portion of the handle panel.

14. The carton of claim 4, wherein the at least one end flap comprises a bottom end flap connected to the bottom panel at a first corner fold line and at least one side end flap connected to one of the first and second side panels at the first corner fold line, wherein the bottom end flap comprises a bottom corner section at least partially defined by the first corner fold line and a second corner fold line, and the at least one side end flap comprises a side corner section at least partially defined by the first and second corner fold lines.

15. The carton of claim 14, wherein the at least one side end flap comprises a first side end flap foldably connected to the first side panel, and the first side panel is connected to the bottom panel at a first transverse fold line, the side corner section comprising a first oblique edge extending from an end of the first transverse fold line, the bottom corner section comprising a second oblique edge extending from the end of the first transverse fold line, and the side corner section and the bottom corner section overlapping proximate to the first and second oblique edges.

16. The carton of claim 14, wherein at least a portion of an outer surface of the at least one side end flap is adhered to at least a portion of an inner surface of the bottom end flap.

17. The carton of claim 1, wherein the at least one end flap comprises a corner section forming a prism corner of the carton.

18. The carton of claim 1 in combination with a plurality of containers, wherein the containers are arranged in at least two columns and at least three rows.

19. The carton in combination with the plurality of containers of claim 15, wherein the containers are arranged in at least three columns and at least four rows.

20. A blank for forming a carton with an at least partially open top, the blank comprising:
a plurality of panels comprising a bottom panel, a first side panel foldably connected to the bottom panel, and a second side panel foldably connected to the bottom panel;
a plurality of end flaps extending along a marginal area of the blank;
a handle panel foldably connected to at least one of the first side panel and the second side panel; and
a reinforcement panel foldably connected to the handle panel.

21. The blank of claim 20, wherein the first side panel is connected to the bottom panel at a first transverse fold line, the second side panel is connected to the bottom panel at a second transverse fold line, and the handle panel is connected to the at least one of the first and second side panels at a third transverse fold line.

22. The blank of claim 21, wherein the reinforcement panel is connected to the handle panel at least one longitudinal fold line.

23. The blank of claim 21, wherein the handle panel is for extending across the at least partially open top of the carton formed from the blank.

24. The blank of claim 20, wherein the handle panel comprises a handle portion and at least one handle flange, wherein the reinforcement panel is foldably connected to the at least one handle flange.

25. The blank of claim 24, wherein the handle portion is narrower than the at least one handle flange.

26. The blank of claim 25, wherein the reinforcement panel comprises a reinforcement handle portion and at least one reinforcement flange, wherein the reinforcement handle portion and the at least one reinforcement flange are correspondingly shaped to the handle portion and the at least one handle flange of the handle panel.

27. The blank of claim 26, wherein the at least one handle flange comprises a first handle flange and a second handle flange, and the at least one reinforcement flange comprises a first reinforcement flange foldably connected to the first handle flange and a second reinforcement flange foldably connected to the second handle flange.

28. The blank of claim 25, wherein the handle panel further comprises at least two handle flaps, each handle flap being foldably connected to the handle portion of the handle panel.

29. The blank of claim 24, wherein the handle portion comprises at least one jagged edge.

30. The blank of claim 24, wherein the at least one handle flange comprises a first handle flange foldably connected to the at least one of the first and second side panels and a second handle flange foldably connected to an adhesive flap.

31. The blank of claim 24, wherein the at least one handle flange is foldably connected to an adhesive flap, the adhesive flap comprising a transverse intermediate fold line.

32. The blank of claim 24, wherein the at least one handle flange is connected to the first side panel at a transverse fold line and the first side panel comprises at least one first curved edge extending from the transverse fold line, wherein the at least one first curved edge is concave.

33. The blank of claim 32, wherein the second side panel comprises a transverse edge and at least one second curved edge extending from the transverse edge, wherein the at least one second curved edge is concave, and the transverse edge overlaps a portion of the handle panel.

34. The blank of claim 24, wherein the plurality of end flaps comprises a bottom end flap connected to the bottom panel at a first corner fold line and at least one side end flap connected to one of the first and second side panels at the first corner fold line, wherein the bottom end flap comprises a bottom corner section at least partially defined by the first corner fold line and a second corner fold line, and the at least one side end flap comprises a side corner section at least partially defined by the first and second corner fold lines.

35. The blank of claim 34, wherein the at least one side end flap comprises a first side end flap foldably connected to the first side panel, and the first side panel is connected to the bottom panel at a first transverse fold line, the side corner section comprising a first oblique edge extending from an end of the first transverse fold line, the bottom corner section comprising a second oblique edge extending from the end of the first transverse fold line, and the side corner section and the bottom corner section being for overlapping proximate to the first and second oblique edges in the carton formed from the blank.

36. The blank of claim 20, wherein each end flap of the plurality of end flaps comprises a corner section for forming a prism corner of the carton formed from the blank.

37. A method for forming a blank into a carton for containing a plurality of containers, the method comprising:
obtaining a blank comprising
a plurality of panels comprising a bottom panel, a first side panel connected to the bottom panel, and a second side panel connected to the bottom panel;
a plurality of end flaps extending along a marginal area of the blank;
a handle panel foldably connected to at least one of the first side panel and the second side panel; and
a reinforcement panel foldably connected to the handle panel;
forming an interior of the carton with an at least partially open top by respectively folding the plurality of panels and the plurality of end flaps.

38. The method of claim 37, further comprising forming a handle comprising:
folding the reinforcement panel into at least partially face-to-face contact with the handle panel; and
forming a handle by folding the handle panel with respect to the at least one of the first side panel and the second side panel so that the handle extends across the at least partially open top.

39. The method of claim 38, wherein the handle is foldably connected to the first side panel at one end of the handle, and the forming the handle comprises affixing an opposing end of the handle to the second side panel.

40. The method of claim 38, wherein the handle comprises a handle portion and at least one handle flange, and the reinforcement panel comprises a reinforcement handle portion and at least one reinforcement flange, and wherein the reinforcement handle portion and the at least one reinforcement flange are correspondingly shaped to the handle portion and the at least one handle flange of the handle panel.

41. The method of claim 37, wherein the forming the interior of the carton further comprises folding the plurality of end flaps to form an at least partially closed end of the carton, wherein at least one end flap of the plurality of end flaps forms a prism corner.

42. The method of claim 41, wherein the plurality of end flaps comprises a bottom end flap and at least one side end flap, and wherein the forming the at least partially closed end of the carton further comprises adhering at least a portion of an inner surface of the bottom end flap to at least a portion of an outer surface of the at least one side end flap.
